(19) United States
(12) Patent Application Publication
(10) Pub. No.: US 2007/0083694 A1
(43) Pub. Date: Apr. 12, 2007

(54) Memory card with multiple transmission interfaces

(75) Inventor: Chien-Yuan Chen, Taipei (TW)

Correspondence Address: TROXELL LAW OFFICE PLLC;SUITE 1404, 5205 LEESBURG PIKE, FALLS CHURCH, VA, 22041, US

(73) Assignees: Chien-Yuan Chen; Power Digital Card Co., Ltd.

(21) Appl. No.: 11/514,348

(22) Filed: Sep. 1, 2006

Related U.S. Application Data
(63) Continuation-in-part of application No. 10/385,735, filed on Mar. 12, 2003, now abandoned.

(51) Int. Cl. G06F 13/14

(52) U.S. Cl. 710/305

(57) ABSTRACT

A memory card with multiple transmission interfaces refers to a memory card for data access, which is in compliance with an adaptation of a memory card and a multi-interface including a universal serial bus (BUS) and an IEEE1394 specification. A gliding block being provided with the specification of the USB or IEEE1394 interface, is displaced along a preset track on the memory card, such that when the gliding block is collected into the memory card, a specification of the memory card is formed; whereas when the gliding block is pushed out of the memory card, the gliding block will be in compliance with the connection specification of a USB port. Accordingly, one memory card is provided with a plurality of transmission functions, and can facilitate a convenience in a mutual connection with a plurality of electronic end products.

### RELATED APPLICATION

This application is a Continuation-In-Part of currently pending U.S. patent application Ser. No. 10/385,735 filed on Mar. 12, 2003.

### BACKGROUND OF THE INVENTION

(a) Field of the Invention

The present invention relates to a memory card with multiple transmission interfaces, and more particularly to a memory card which is used for data storage and accessing and is provided with multiple kinds of interface connections at a same time, so as to achieve a fast data transmission and to provide convenience.

(b) Description of the Prior Art

As a memory card used in an electronic product such as a digital camera, an MP3 player, a notebook computer, a cellular phone, and a personal digital assistant, is provided with advantages of a large capacity, a small size, and portability, it is widely used in the market. In addition, vendors are continuously developing all kinds of memory cards to meet requirements of consumers. The memory cards available in the existing market include primarily an SD (Smart Digital) memory card, an MS (Memory Stick) memory card, a CF (Compact Flash) memory card, an SM (Smart Media) memory card, an MMC (Multi Media Card) memory card, and an MD (IBM Micro Drive) memory card, with different shapes and sizes. In order that the data stored in the memory card can be accessed in a computer system, a card reader should be used. However, as there are so many kinds of memory cards in the market, the consumer will have to own many kinds of card readers or a multi-purpose card reader that can access different kinds of memory cards, which is not economic and will also cause a trouble in carrying the card readers. Moreover, as the storage capacity of memory card is getting larger, a size of file to be processed is getting larger; whereas data transmission speed is limited to access speed of a USB (Universal Serial Bus) interface or a memory. Although the memory card can be directly inserted into the notebook computer for accessing data, using a PCMCIA (Personal Computer Memory Card International Association) adaptive and expansion slot, to prevent the shortcoming that the access speed of the USB interface is too slow, it is eventually limited to the access speed of flash memory. In addition, this kind of adaptive card can be only used in the notebook computer, and different notebook computers will have different slot types; therefore, the problem that the data access is too slow cannot be solved at all.

A flash EEPROM (Electrically Erasable Programmable Read Only Memory) system, which is disclosed in the U.S. Pat. No. 5,602,987, is shown in FIG. 1. This prior art primarily provides a memory system to connect to a memory card of a computer system, wherein a flash EEPROM array A33 is connected to a controller A31, so as to constitute a set of non-volatile memory A29, followed by constituting at least one set of input-output (I/O) device A27 which is connected to a micro-processor A21 and a RAM (Random Access Memory) A25 through a system bus A23, to maintain an accuracy for a large number of write/erase cycles. However, the primary shortcoming of the prior art is that it cannot meet the requirements of high-speed transmission and generality.

Additionally, architecture for a universal serial bus-based PC flash disk, which is disclosed in the U.S. Pat. No. 6,148,354, is shown in FIG. 2. This prior art includes primarily a connection interface A64 which is serially connected between a flash component A58 and a USB connector A52. The connection interface A64 is composed of a USB logical/physical interface A66 and a USB function interface A68. The USB function interface A68 transmits signals, which are processed by an application packet extractor A70, an application command interpreter A72, an address resolver A74, a data and status handler A76, and a memory technology driver (MTD), to the flash component A58. Accordingly, a set of flash memories which is accessible and erasable is constituted by the aforementioned components. However, the primary shortcomings of prior art are that it can be only connected to the computer, cannot be in compliance with a peer-to-peer networking structure between terminal equipment, and cannot achieve a purpose of resource sharing.

On the other hand, for a structure where the USB and memory card interfaces are installed on a storage device for data access at a same time, a dual-interface data transmission can be achieved. Nevertheless, there are still shortcomings to be improved, as follows.

1. As a thickness of memory card is not the same as that of the USB, the appearance of memory card will be different in height and is less smooth. Therefore, when the memory card is inserted into a card connector, it is easy to be hooked at a conduction terminal in the card connector, which deforms the internal terminal, thereby severely affecting an accuracy and stability in connecting with the memory card to be inserted.

2. For the conventional dual-interface memory card, the I/O junctions on the USB are exposed out of the memory card. Therefore, when the memory card is inserted into and pulled out of digital peripheral equipment, the I/O junctions will be in touch with a human body, which enables the I/O junctions to be rusted easily, thereby causing a difficulty in data transmission.

### SUMMARY OF THE INVENTION

Accordingly, in view of the shortcomings of prior arts, the primary object of present invention is to enable a memory card for data access to be provided with a dual-interface specification including an interface which is in compliance with the USB or IEEE 1394, and a memory card interface, without affecting a standard thickness, specification, and appearance of the memory card.

Another object of the present invention is to provide a memory card, such that a touch of the USB interface by a human body can be decreased in using the memory card, so as to prevent the interface from being rusted and oxidized by sweat.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a prior art.

FIG. 2 shows a block diagram of another prior art.

FIG. 3 shows a schematic view of structure of a first embodiment of the present invention.

FIG. 4 shows a schematic view of an assembly of a first embodiment of the present invention.

FIG. 5 shows a second schematic view of an assembly of a first embodiment of the present invention.

FIG. 6 shows a cutaway view of FIG. 5.

FIG. 7 shows a schematic view of using a first embodiment of the present invention.

FIG. 8 shows a cutaway view of FIG. 7.

FIG. 9 shows a block diagram of data transmission of a first embodiment of the present invention.

FIG. 10 shows a schematic view of a circuit structure of the present invention.

FIG. 11 shows a schematic view of structure of a second embodiment of the present invention.

FIG. 12 shows a schematic view of structure of a third embodiment of the present invention.

FIG. 13 shows a schematic view of structure of a fourth embodiment of the present invention.

FIG. 14 shows a cutaway view of a memory card of a fourth embodiment of the present invention.

FIG. 15 shows a schematic view of using a fourth embodiment of the present invention.

FIG. 16 shows another schematic view of using a fourth embodiment of the present invention.

FIG. 17 shows a schematic view of structure of a fifth embodiment of the present invention.

FIG. 18 shows a second schematic view of structure of a fifth embodiment of the present invention.

FIG. 19 shows a schematic view of structure of a sixth embodiment of the present invention.

FIG. 20 shows a second schematic view of structure of a sixth embodiment of the present invention.

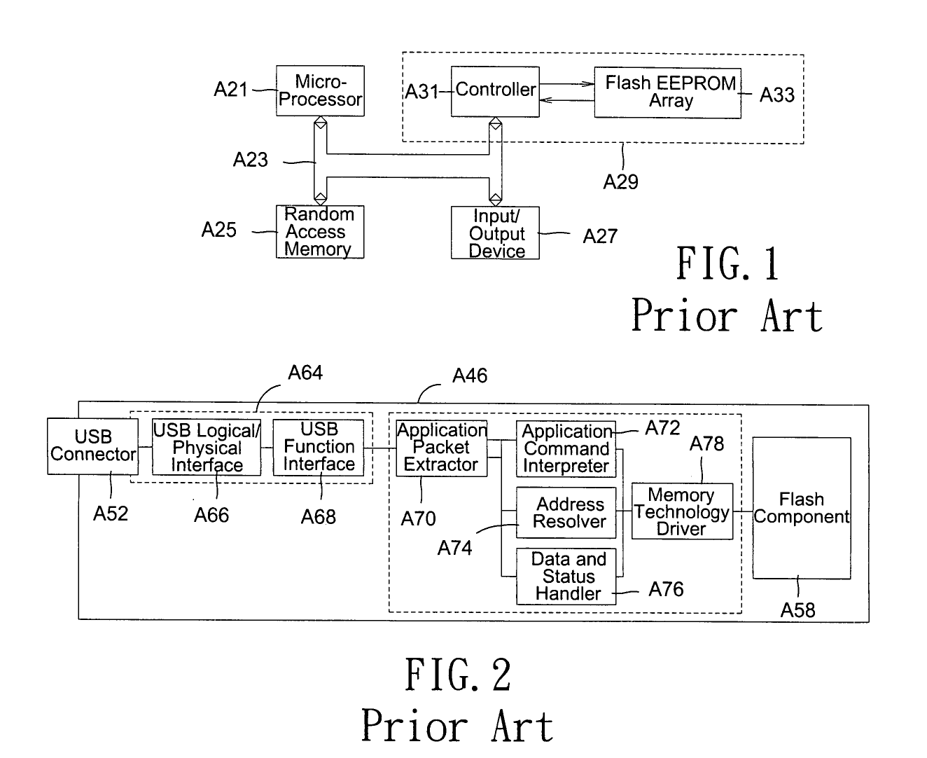

### DETAILED DESCRIPTION OF THE PREFERRED EMBODIMENTS

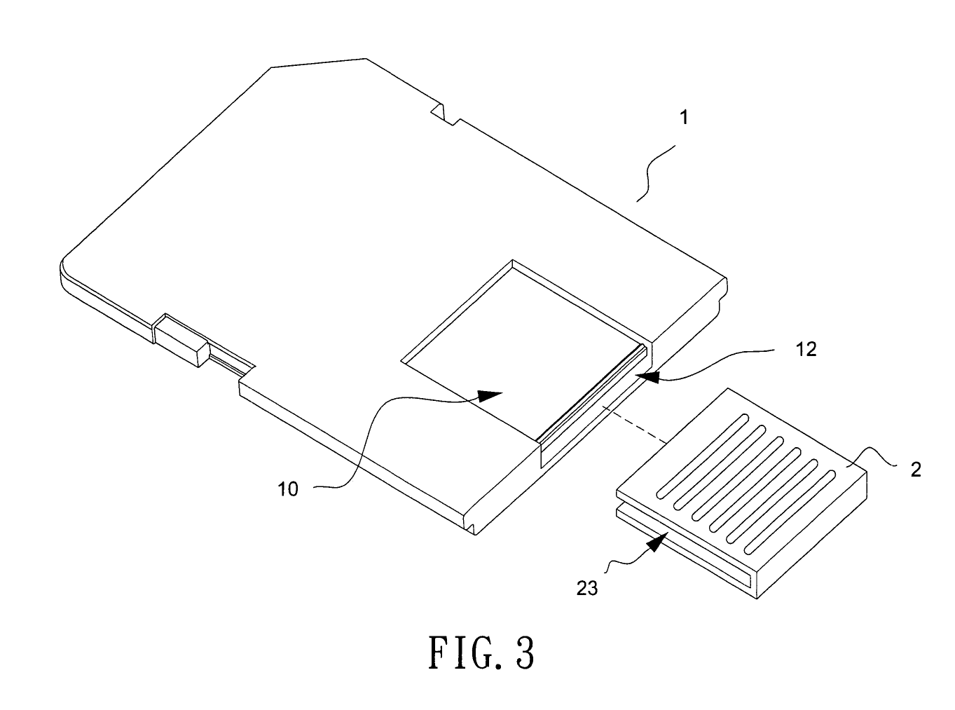

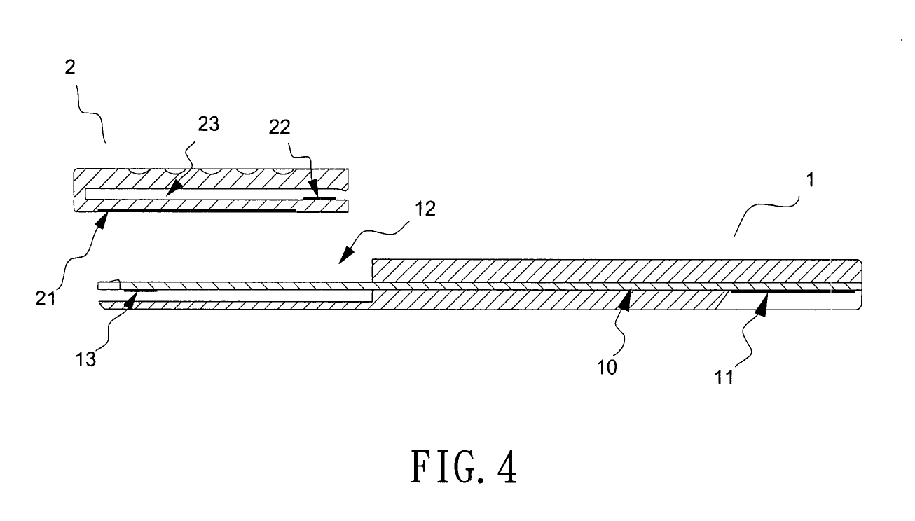

Referring to FIG. 3, which shows a schematic view of structure of a first embodiment of the present invention, along with referring to other drawings at a same time, the embodiment is in compliance with a size and appearance of a Secure Digital card (or SD card in short). A memory card 1 is provided with a base 10 which is pre-configured with a memory module. The base 10 can be a circuit board, an end of which is provided with a memory card interface 11 for accessing external data, and the other end of which is protruded with a junction (I/O) 13 for electrically connecting with a gliding block 2 (as shown in FIG. 4). A holding slot 12 for containing the gliding block 2 is concaved on the memory card 1, at an end which is opposite to the memory card interface 11, wherein the memory card interface 11 can be an SD (Smart Digital) memory card, an MS (Memory Stick) memory card, a CF (Compact Flash) memory card, an SM (Smart Media) memory card, an MMC (Multi Media Card) memory card, and an MD (IBM Micro Drive) memory card, etc., and the holding slot 12 can be located at a left, right side, or in a middle of the memory card 1.

The gliding block 2 is a C-shape hollow block, a side of which is provided with a connection interface (I/O) 21 complied with the universal serial bus (USB) interface or the 1394 interface specified by the Institute of Electrical and Electronics Engineers (IEEE) (IEEE1394 in short). The entire appearance, size, and thickness of the gliding block 2 are in compliance with the specification of USB or the standard IEEE1394 specification. A C-shape central groove 23 of the gliding block 2 can provide for an emplacement of the base 10 on the memory card 1, and an interior of the groove 23 is provided with a transmission interface 22 for electrically connecting with the aforementioned junction (I/O) 13 of base 10.

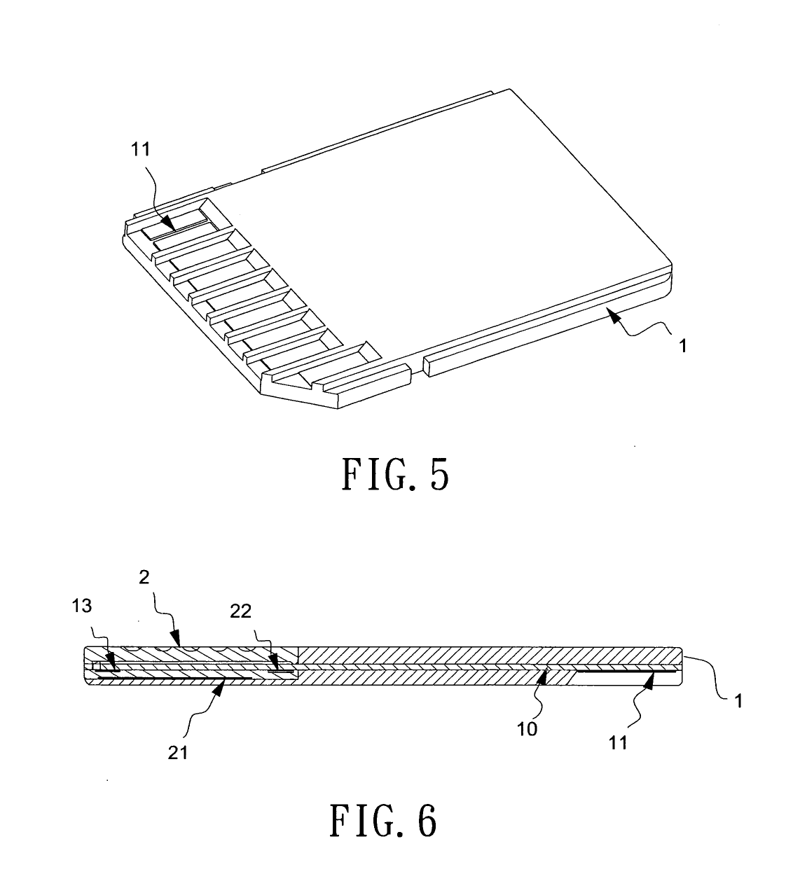

The primary characteristic of the present invention is that a depth of the holding slot 12 is exactly a thickness of the gliding block 2. Therefore, when the gliding block 2 is collected in the holding slot 12 in the memory card 1, the appearance and size after assembling will be in compliance with an outline of memory card (as shown in FIG. 5 and FIG. 6), and the thickness of gliding block 2 which is provided with the USB interface or the IEEE1394 standard interface will be in compliance with the size and thickness of standard USB or IEEE1394 interface. Accordingly, the shortcoming caused by the different thicknesses of two kinds of interfaces can be effectively improved.

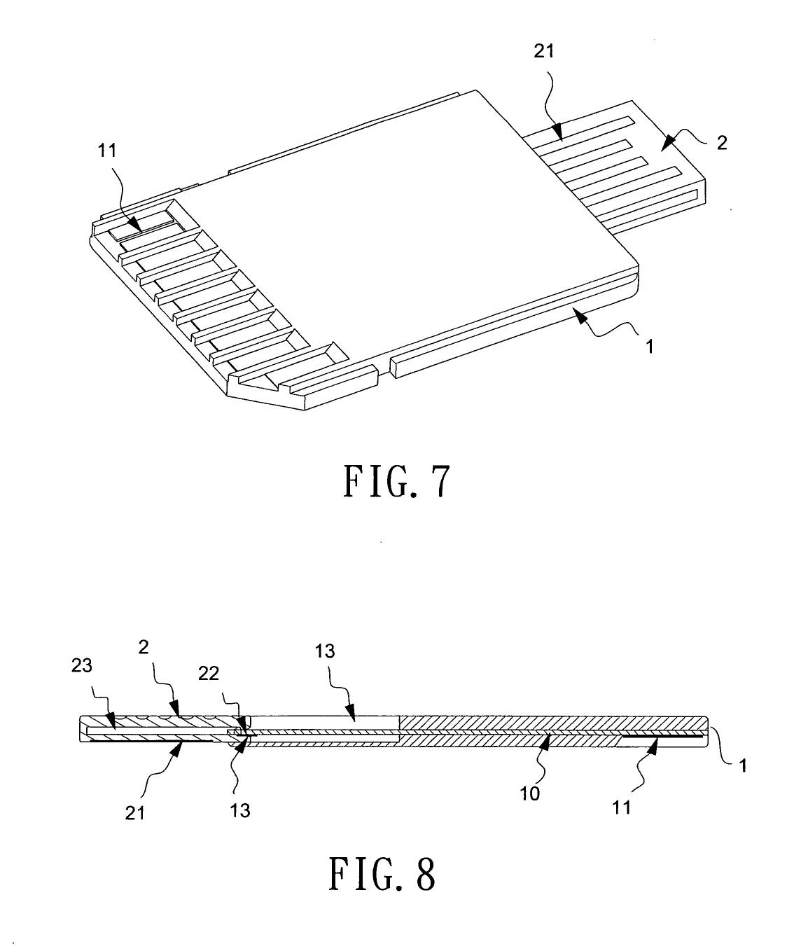

The gliding block 2 of present invention can be displaced toward a front and back along a preset track of the base 10 on the memory card 1 through a preset space provided by the groove 23 (as shown in FIG. 7 and FIG. 8). In addition, when the gliding block 2 is assembled on the memory card 1, the connection interface (I/O) 21, which is in compliance with the specification of USB interface or the IEEE1394 standard interface, on the gliding block 2 is allocated between the memory card 1 and the gliding block 2, such that when the junction (I/O) 21 is not in use, it can be hidden between the memory card 1 and the gliding block 2, to reduce a condition of getting rusted due to a man-made touch. As the connection interface (I/O) 21 on the gliding block 2 is electrically connected with the junction (I/O) 13 of memory card 1 through the transmission interface 22 of gliding block 2, when the gliding block 2 is pushed out of the holding slot 12 of memory card 1, the transmission interface 22 on the gliding block 2 will be in touch with the junction (I/O) 13 in the holding slot 12, enabling the connection interface (I/O) 21 on the gliding block 2 to be at a conduction state. On the contrary, when the gliding block 2 is collected into the memory card 1, as the transmission interface 22 on the gliding block 2 is not in touch with the junction (I/O) 13 of memory card 1, the connection interface (I/O) 21 on the gliding block 2 is indeed inoperable.

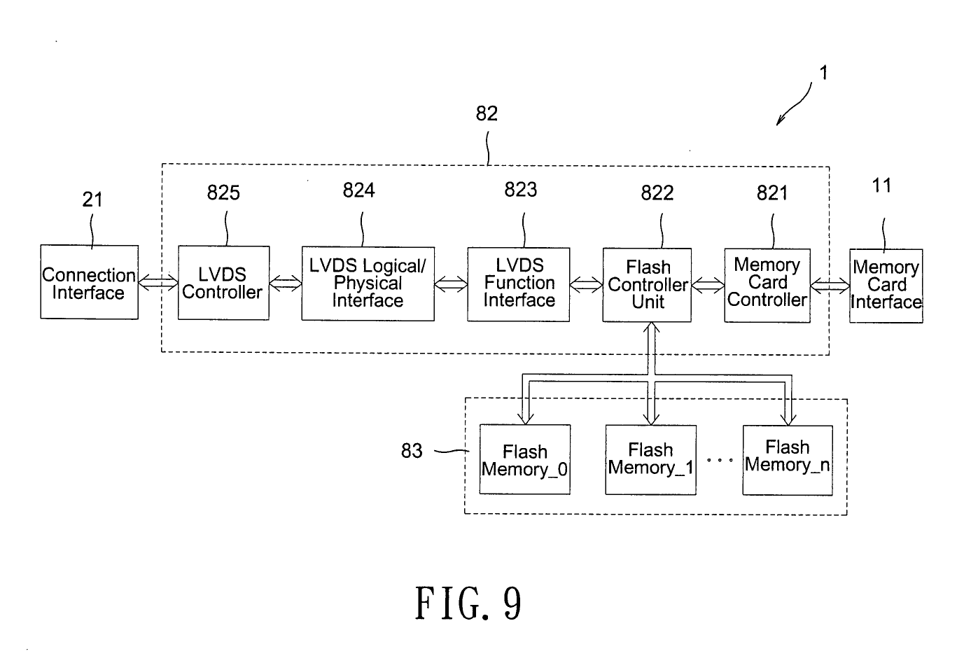

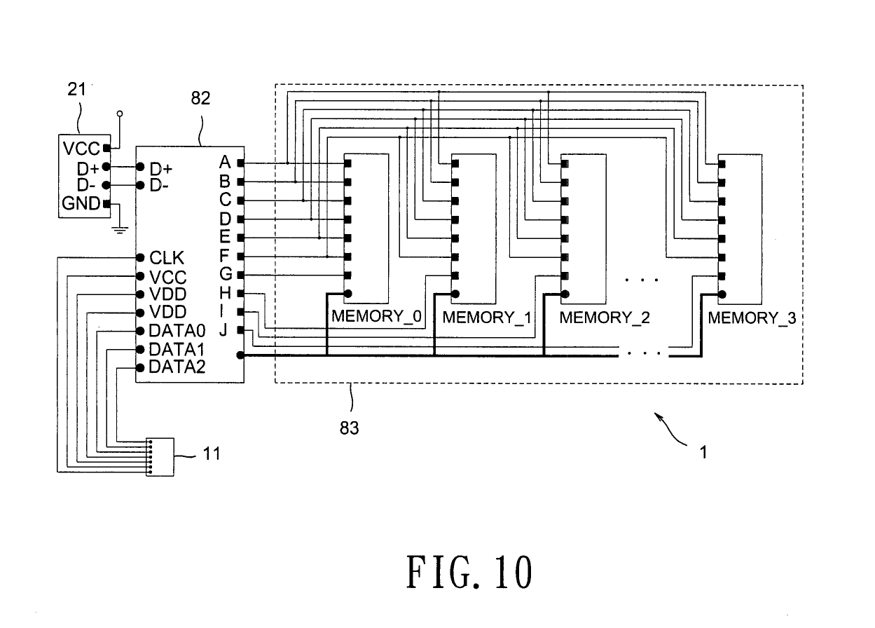

Referring to FIG. 9 and FIG. 10, it shows a block diagram of data transmission and a circuit diagram in the memory card. The base in the memory card 1 is a circuit board, and the aforementioned memory card interface 11 and the connection interface 21 are all electrically connected with the base on which is provided with a control chip 82 to be connected with the memory card 11, and at least one memory chip 83 to be connected with the control chip 82 and the connection interface 21. The aforementioned control chip 82 which is provided with a dual-interface control function includes a memory card controller 821, a flash controller unit 822, a low voltage differential signaling (LVDS) function interface 823, an LVDS logical/physical interface 824, and an LVDS controller 825. The memory card 1 can be directly connected to a computer system through the connection interface 21, such that data can be transmitted between the computer system and the memory card 1, and can be transformed by the control chip 82. Therefore, the control chip 82 is formed with a dual-interface design, with one side being the memory card interface 11, and the other side being the connection interface 21 such as the USB or IEEE 1394 high-speed interface. Accordingly, the USB circuit structure of present invention is assembled by the LVDS-related circuits, wherein the USB and the memory card control circuit structure are decomposed and re-integrated into a new circuit structure, followed by being packaged into a single control chip through SOC (System-On-Chip).

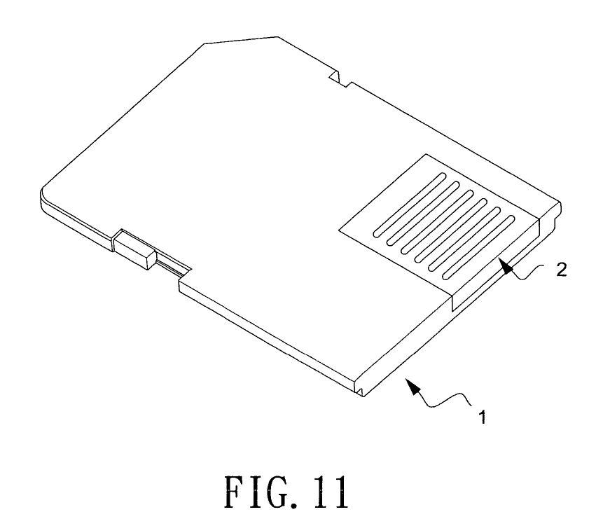

Referring to FIG. 11, it shows a schematic view of structure of a second embodiment of the present invention. The embodiment is different than the first embodiment in that the position of holding slot 12 is located at a side of the memory card 1, such that when the gliding block 2 which is in compliance with the USB is assembled in the holding slot 12, the gliding block 2 can be installed at the side of memory card 1, thereby providing a user with another kind of assembly method in accordance with equipment requirement.

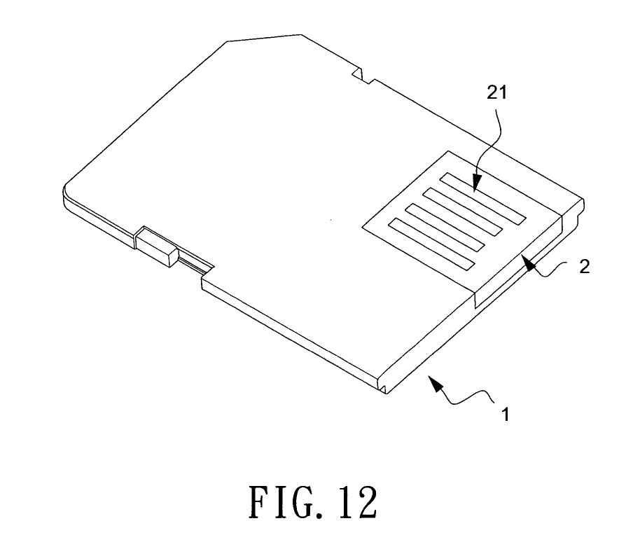

Referring to FIG. 12, it shows a schematic view of structure of a third embodiment of the present invention. The embodiment is different than the first embodiment in that the connection interface (I/O) 21 of the specification of USB or IEEE1394 interface is located at the other side of the gliding block 2, such that when the gliding block 2 is assembled on the memory card 1, the USB or IEEE1394 on the gliding block 2 are exposed out. However, in spite of the exposition, as there is enough space for operation, the problem of getting rusted due to a touch by hands is not a concern; therefore, it is not to be described further.

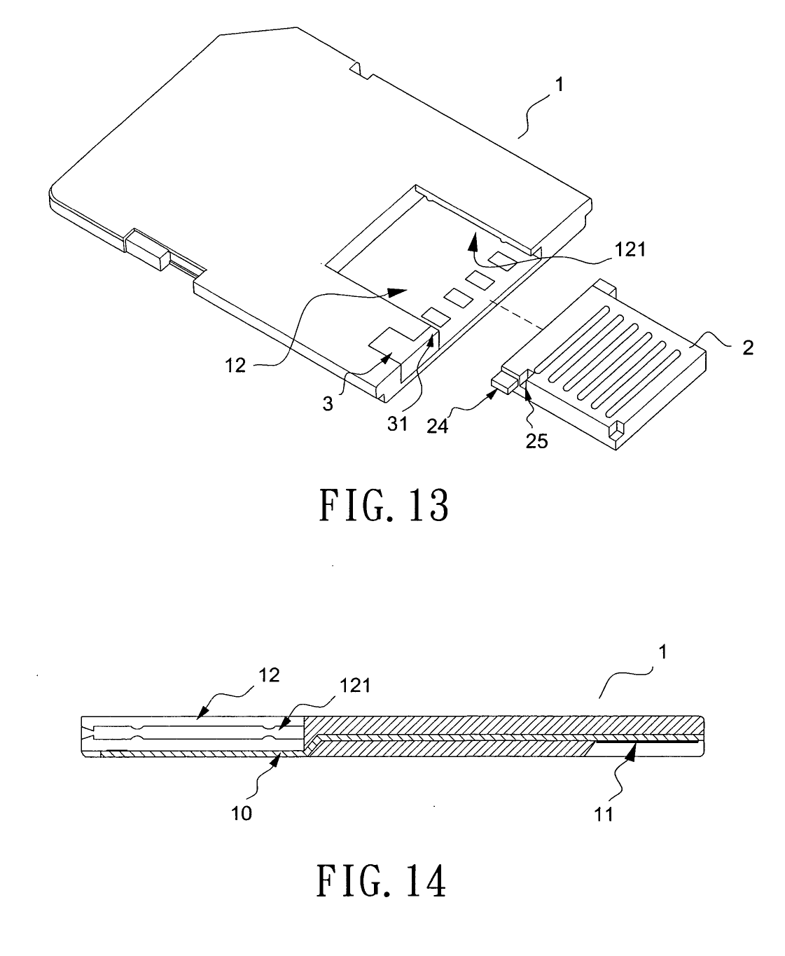

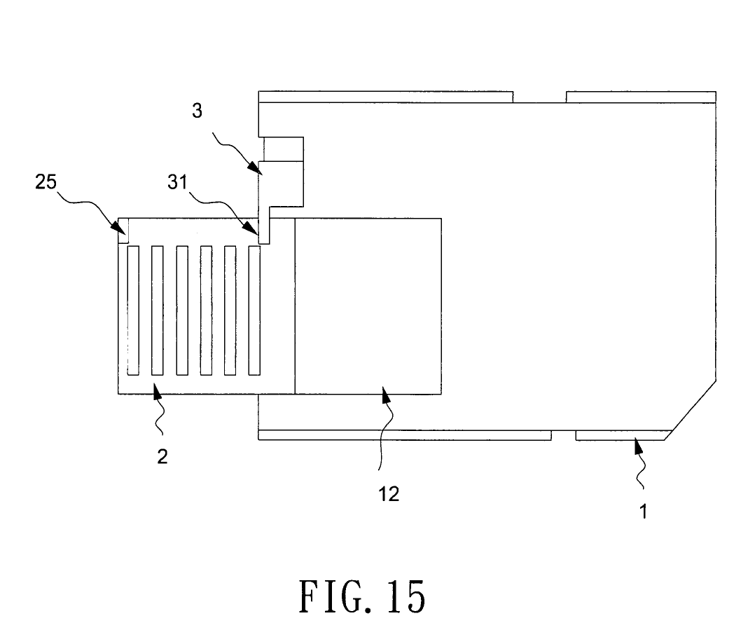

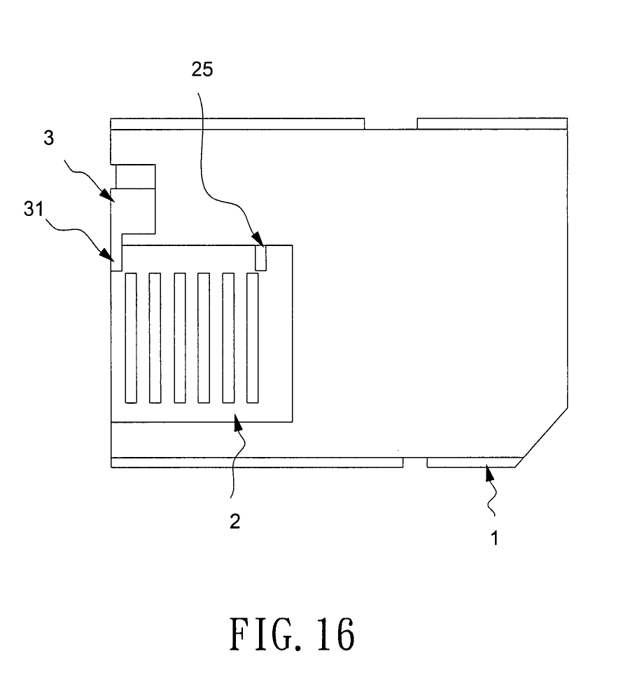

Referring to FIG. 13, it shows a schematic view of structure of a fourth embodiment of the present invention. The embodiment is different than the first embodiment in that the base 10 which is used by the memory card 1 for configuring the memory module is a circuit board assembled by a soft and a hard material, which is assembled along a bottom surface of the holding slot 12 outward, in the memory card 1 (as shown in FIG. 14). In addition, two sides of the holding slot 12 are concaved with slides 121, a bottom of the memory card 1 is provided with a push rod 3 which is extended outward with a locking tenon 31, and the gliding block 2 is a solid block with two sides of which being protruded with projection lumps 24, such that the gliding block 2 can be displaced along a preset track in the slides 121 of memory card 1. A groove 25 is located on the gliding block 2, at a position relative to the push rod 3 of memory card 1, such that when the gliding block 2 is pushed out, an abut is formed by using the locking tenon 31 to be really positioned (as shown in FIG. 15 and FIG. 16). As the assembly structure and operation of the embodiment are all the same as those of the first embodiment, further description is not needed.

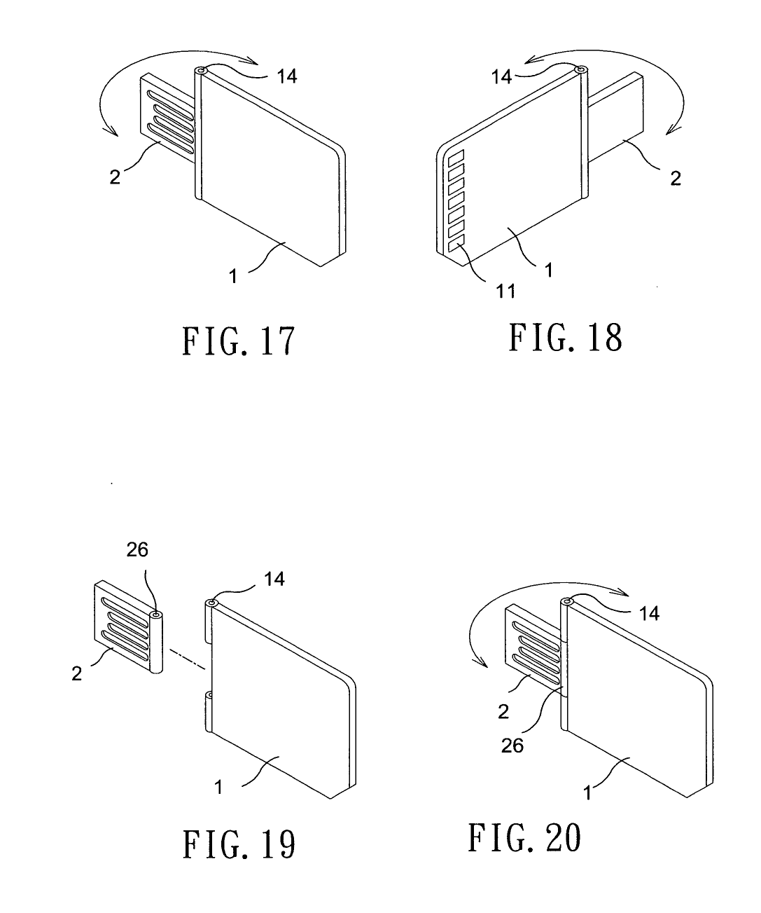

Referring to FIG. 17 and FIG. 18, it shows a first and a second schematic view of structure of a fifth embodiment. The gliding block 2 and the memory card 1 of the embodiment are pivoted with a shaft 14, such that a variety of orientations can be implemented to the gliding block 2 on the memory card 1 through the shaft 14, without being limited by space. As the method of circuit connection of the embodiment is the same as that of the aforementioned embodiment, further description is not needed.

The pivoting method can also be like that in FIG. 19 and FIG. 20, wherein the memory card 1 and the gliding block 2 are all provided with shafts 14, 26, such that the gliding block 2 can manifest a variety of orientations on the memory card 1 through a mutual pivoting of the shafts 14, 26.

Accordingly, the dual-interface-connection memory card of present invention can indeed provide the connection of two interfaces of different specifications, and can prevent from resulting in the condition of getting rusted from the man-made touch.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A memory card with multiple transmission interfaces referring to a memory card for data access, which is in compliance with an adaptation of a memory card and a dual-interface including a universal serial bus (USB) and an IEEE1394 specification, comprising a gliding block being provided with the specification of the USB or IEEE1394 interface, which is displaced along a preset track on the memory card, such that when a base is collected into the memory card, an outline of the memory card is formed, whereas when the gliding block is pushed out of the memory card, the gliding block will be in compliance with the connection specification of a USB port.

2. The memory card with multiple transmission interfaces according to claim 1, wherein the memory card is directly connected with a junction of USB or IEEE1394 at an external device end by being provided with or externally connected with a USB or IEEE1394 interface end, to transmit data, and to form an only controller without using another adaptive device.

3. The memory card with multiple transmission interfaces according to claim 1, wherein the USB or IEEE1394 which serves as a connection interface (I/O) for data transmission, is installed between the base and the memory card.

4. The memory according with multiple transmission interfaces according to claim 1, wherein the USB which serves as a connection interface (I/O) for data transmission, is installed at an exterior side of the memory card.

5. The memory card with multiple transmission interfaces according to claim 1, wherein the gliding block is clamped at a PC (Printed Circuit) board of memory card, and is pulled out or collected using the PC board as a slide.

6. The memory card with multiple transmission interfaces according to claim 1, wherein the gliding block is assembled with the memory card, such that a projection lump and a preset slide are used for pushing out or collecting the gliding block.

7. The memory card with multiple transmission interfaces according to claim 1, wherein the gliding block is pivoted with the memory card, such that the gliding block manifests a variety of orientations on the memory card.
